(19) United States
(12) Patent Application Publication
(10) Pub. No.: US 2021/0278008 A1
(43) Pub. Date: Sep. 9, 2021

(54) SOLENOID

(71) Applicant: DENSO CORPORATION, Kariya-city (JP)

(72) Inventor: Kazuhiro SASAO, Kariya-city (JP)

(21) Appl. No.: 17/327,283

(22) Filed: May 21, 2021

Related U.S. Application Data
(63) Continuation of application No. PCT/JP2019/045565, filed on Nov. 21, 2019.

(30) Foreign Application Priority Data
Nov. 26, 2018 (JP) 2018-219982

(51) Int. Cl. F16K 31/06; H01F 7/16

(52) U.S. Cl. CPC F16K 31/0613; F16K 31/0675; H01F 7/1607

(57) ABSTRACT

A solenoid includes: a coil that generates magnetic force when energized; a plunger formed in a columnar shape and configured to slide in an axial direction; a yoke provided along the axial direction and includes a tubular portion; a bottom opposed to a base end surface of the plunger; and a stator core. The stator core includes: a magnetic attraction core that magnetically attracts the plunger by magnetic force; a slide core; and a magnetic flux passage restricting portion that restricts passage of the magnetic flux between the slide core and the magnetic attraction core. The slide core includes: a core portion arranged radially outside the plunger; and a magnetic flux transmitting portion that expands radially outward from an end portion of the core portion. The yoke includes a magnetic flux passage area expansion portion that is formed on the tubular portion and protrudes radially inward from the tubular portion.

### CROSS REFERENCE TO RELATED APPLICATIONS

The present application is a continuation application of International Patent Application No. PCT/JP20191045565 filed on Nov. 21, 2019, which designated the U.S. and claims the benefit of priority from Japanese Patent Applications No. 2018-219982 filed on Nov. 26, 2018. The entire disclosures of all of the above applications are incorporated herein by reference.

### TECHNICAL FIELD

The present disclosure relates to a solenoid.

### BACKGROUND

A known solenoid includes a coil which generates magnetic force by energization, a stator core arranged radially inside the coil, and a plunger which slides on an inner peripheral side of the stator core.

### SUMMARY

According to an aspect of the present disclosure, a solenoid includes: a coil configured to generate magnetic force when energized; a plunger formed in a columnar shape, arranged radially inside the coil, and configured to slide in an axial direction; a yoke that houses the coil and the plunger, includes a tubular potion, and is provided along the axial direction; a bottom provided along a direction that intersects the axial direction and opposed to a base end surface of the plunger; and a stator core. The stator core includes a magnetic attraction core, a slide core, and a magnetic flux passage restricting portion. The magnetic attraction core is opposed to a front end surface of the plunger in the axial direction and configured to magnetically attract the plunger by magnetic force generated by the coil. The slide core includes: a core portion formed in a tubular shape and arranged radially outside the plunger; and a magnetic flux transmitting portion that expands radially outward from an end portion of the core portion that is opposed to the bottom. The magnetic flux transmitting portion is configured to transmit magnetic flux between the yoke and the plunger through the core portion. The magnetic flux passage restricting portion is configured to restrict passage of the magnetic flux between the slide core and the magnetic attraction core. The yoke includes a magnetic flux passage area expansion portion such that the magnetic flux passes from the yoke to the magnetic flux transmitting portion through an area equal to a predetermined area threshold or larger. The magnetic flux passage area expansion portion is formed on the tubular portion and protrudes radially inward from an inner peripheral surface of the tubular portion.

### BRIEF DESCRIPTION OF DRAWINGS

The above and other objects, features and advantages of the present disclosure will become more apparent from the following detailed description made with reference to the accompanying drawings. In the drawings:

FIG. 1 is a sectional view showing a schematic structure of a solenoid applied to a linear solenoid valve according to a first embodiment.

FIG. 2 is a sectional view showing a detailed structure of the solenoid.

FIG. 3 is a sectional view taken along a line in FIG. 2.

FIG. 4 is a sectional view showing a solenoid in a comparative example.

FIG. 5 is a sectional view taken along a line V-V in FIG. 4.

FIG. 6 is a sectional view showing a ring core eccentrically assembled.

FIG. 7 is a sectional view showing a detailed structure of a solenoid according to a second embodiment.

FIG. 8 is a sectional view showing a detailed structure of a solenoid according to a third embodiment.

FIG. 9 is a sectional view showing a detailed structure of a solenoid according to a fourth embodiment.

FIG. 10 is a sectional view showing a detailed structure of a solenoid according to a fifth embodiment.

FIG. 11 is a sectional view showing a detailed structure of a solenoid according to a sixth embodiment.

FIG. 12 is a sectional view showing a detailed structure of a solenoid according to a seventh embodiment.

FIG. 13 is a sectional view showing a detailed structure of a solenoid according to an eighth embodiment.

FIG. 14 is a sectional view showing a detailed structure of a solenoid according to a ninth embodiment.

### DETAILED DESCRIPTION

A solenoid may include a coil which generates magnetic force by energization, a stator core arranged radially inside the coil, and a plunger which slides on an inner peripheral side of the stator core. In a solenoid, a magnetic ring core may be arranged on an outer peripheral side of a stator core. Because of this, magnetic circuit components such as a yoke and the stator core are magnetically coupled through the ring core. Therefore, deterioration of magnetic force due to a gap between the magnetic circuit components and the stator core which are assembled is restricted.

In the solenoid described above, the ring core is movable in a radial direction. Therefore, the ring core may be assembled so as to be eccentric to a slide core, and a size of a gap between the slide core and the ring core may be biased in the radial direction. In this case, distribution of magnetic flux transmitted to the slide core and a plunger through the ring core may be biased in the radial direction, and attractive force in the radial direction may be generated as side force. If the side force is increased, slidability of the plunger may be deteriorated. Therefore, the plunger is desired to be protected from the deterioration of the slidability.

The present disclosure can be implemented in the follow manners.

According to an exemplar embodiment of the present disclosure, a solenoid includes: a coil configured to generate magnetic force when energized; a plunger formed in a columnar shape, arranged radially inside the coil, and configured to slide in an axial direction; a yoke that houses the coil and the plunger, includes a tubular potion, and is provided along the axial direction; a bottom provided along a direction that intersects the axial direction and opposed to a base end surface of the plunger; and a stator core. The stator core includes a magnetic attraction core, a slide core, and a magnetic flux passage restricting portion, The magnetic attraction core is opposed to a front end surface of the plunger in the axial direction and configured to magnetically attract the plunger by magnetic force generated by the coil. The slide core includes: a core portion formed in a tubular shape and arranged radially outside the plunger; and a magnetic flux transmitting portion that expands radially outward from an end portion of the core portion that is opposed to the bottom. The magnetic flux transmitting portion is configured to transmit magnetic flux between the yoke and the plunger through the core portion. The magnetic flux passage restricting portion is configured to restrict passage of the magnetic flux between the slide core and the magnetic attraction core. The yoke includes a magnetic flux passage area expansion portion such that the magnetic flux passes from the yoke to the magnetic flux transmitting portion through an area equal to a predetermined area threshold or larger. The magnetic flux passage area expansion portion is formed on the tubular portion and protrudes radially inward from an inner peripheral surface of the tubular portion.

In the solenoid described above, the slide core includes the core portion and the magnetic flux transmitting portion. The core portion has a tubular shape and is arranged radially outside the plunger. The end portion of the core portion is opposed to the bottom, The magnetic flux transmitting portion extends radially outward from the end portion of the core portion. The magnetic flux transmitting portion is configured to transmit the magnetic flux between the yoke and the plunger through the core portion. That is, a gap between the core portion and the magnetic flux transmitting portion in the radial direction is not provided. Because of this, distribution of the magnetic flux transmitted from the magnetic flux transmitting portion to the plunger through the core portion can be restricted from being biased in the radial direction, and generation of side force due to bias of magnetic flux distribution can be restricted. Therefore, the slidability of the plunger can be protected from the deterioration.

The present disclosure can be implemented by various forms. For example, the present disclosure can be implemented in a solenoid valve, manufacturing method for a solenoid, or the like,

### A. First Embodiment

### A-1. Configuration

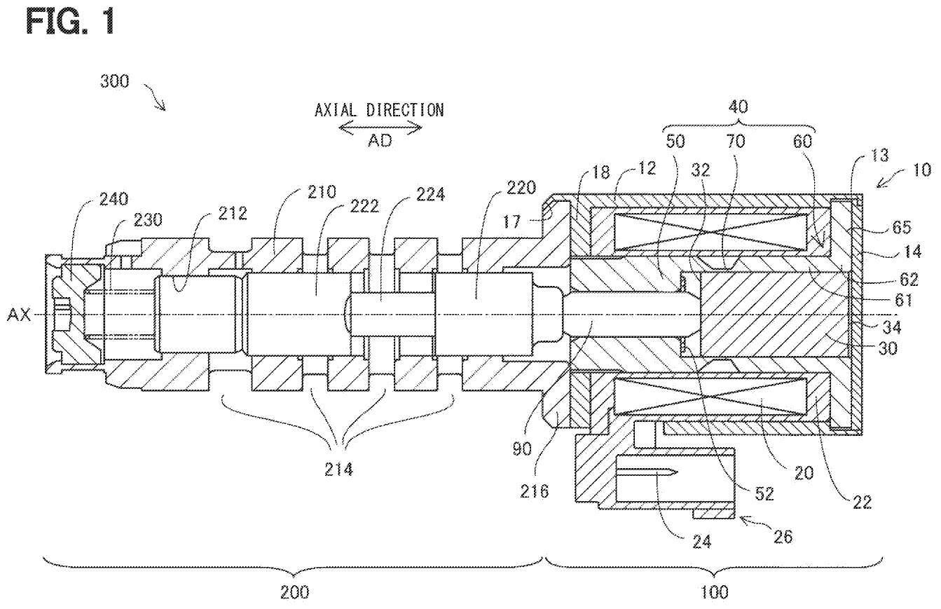

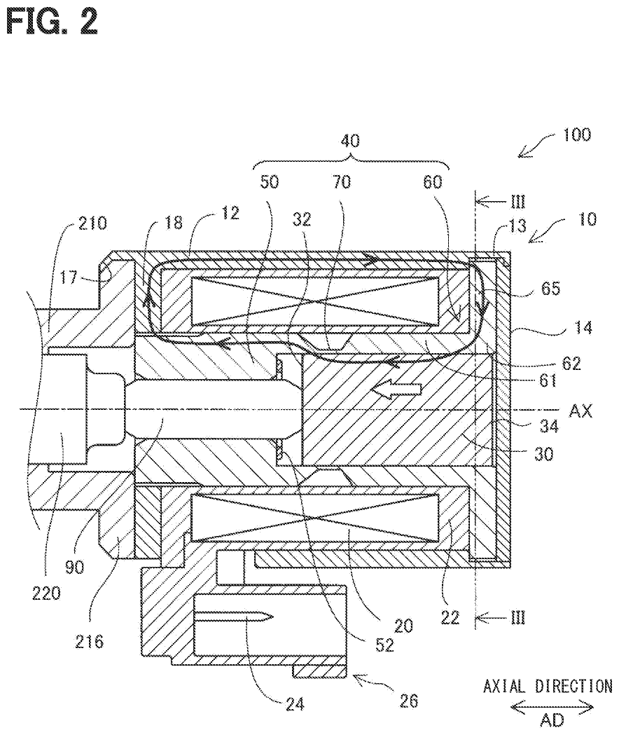

FIG. 1 shows a solenoid 100 in a first embodiment. The solenoid 100 is applied to a linear solenoid valve 300 and functions as an actuator to drive a spool valve 200. The linear solenoid valve 300 is configured to control a hydraulic pressure of hydraulic oil supplied to an unillustrated vehicle automatic transmission and is arranged in an unillustrated hydraulic circuit. The spool valve 200 and the solenoid 100 included in the linear solenoid valve 300 are arranged along a central axis AX. FIGS. 1 and 2 show the solenoid 100 and the linear solenoid valve 300 in a non-energized state. The linear solenoid valve 300 in the present embodiment is a normally closed type. However, the linear solenoid valve 300 may be a normally open type.

The spool valve 200 shown in FIG. 1 controls communication states and opening areas of multiple oil ports 214 which will be described below. The spool valve 200 includes a sleeve 210, a spool 220, a spring 230, and an adjust screw 240.

The sleeve 210 has an appearance of a substantially cylindrical shape. In the sleeve 210, an insertion hole 212 and the multiple oil ports 214 are formed. The insertion hole 212 penetrates along the central axis AX. The oil port 214 is communicated to the insertion hole 212 and opens in a radial direction. The spool 220 is inserted into the insertion hole 212. The multiple oil ports 214 are arranged in a direction which is parallel to the central axis AX and is referred to as axial direction AD hereinafter. The multiple oil ports 214 correspond to, for example, an inlet port communicated to an unillustrated oil pump and configured to receive supply of hydraulic pressure, an outlet port communicated to an unillustrated clutch piston and through which the hydraulic pressure is supplied, a drain port through which the hydraulic oil is discharged, or the like. A flange 216 is formed on an end of the sleeve 210 close to the solenoid 100. The flange 216 includes a part which has a diameter expanded radially outward. The flange 216 and a yoke 10 of the solenoid 100 which will be described below are fixed to each other.

The spool 220 has an appearance of a substantially bar shape such that multiple large-diameter portions 222 and a small-diameter portion 224 are arranged along the axial direction AD. The spool 220 slides along the axial direction AD in the insertion hole 212 and controls the communication states and the opening areas of the multiple oil ports 214 corresponding to positions of the large-diameter portions 222 and the small-diameter portion 224 in the axial direction AD. A shaft 90 abuts against one end of the spool 220 and is configured to transmit thrust of the solenoid 100 to the spool 220. The spring 230 is arranged on the other end of the spool 220 and includes a compression coil spring. The spring 230 presses and biases the spool 220 toward the solenoid 100 in the axial direction AD. The adjust screw 240 abuts against the spring 230. A spring load of the spring 230 is controlled by adjusting a depth of the adjust screw 240 screwed on the sleeve 210.

Energization of the solenoid 100 shown in FIGS. 1 and 2 is controlled by an unillustrated electronic control unit to drive the spool valve 200. The solenoid 100 includes the yoke 10, a bottom 14, a coil 20, a plunger 30, and a stator core 40.

The yoke 10 is made of magnetic metal and forms an outer frame of the solenoid 100 as shown in FIG. 2, The yoke 10 has an appearance of a substantially cylindrical shape and houses the coil 20, the plunger 30, and the stator core 40. The yoke 10 includes a tubular portion 12, an opening portion 17, and a wall portion 18.

The tubular portion 12 has an appearance of a substantially cylindrical shape along the axial direction AD. A thin portion 13 is provided on one end of the tubular portion 12 at an opposite side of the spool valve 200 and is formed in a thin shape. The opening portion 17 is formed on the other end of the tubular portion 12 close to the spool valve 200. The opening portion 17 is caulked and fixed to the flange 216 of the spool valve 200 after components of the solenoid 100 are assembled in the yoke 10. The wall portion 18 is positioned between the coil 20 and the flange 216 of the spool valve 200 in the axial direction AD and formed radially inward from the tubular portion 12. The magnetic flux is transmitted between the stator core 40 and the tubular portion 12 of the yoke 10 through the wall portion 18. A small gap is formed between the wall portion 18 and the stator core 40 in the radial direction. By the gap, dimensional variation of the stator core 40 in manufacturing and axis deviation in assembly are absorbed, and a defect in an assembly process is restricted.

The bottom 14 has an appearance of a disk shape and is arranged on an end of the yoke 10 at the opposite side of the spool valve 200. The bottom 14 is perpendicular to the axial direction AD and closes an end opening of the tubular portion 12. The bottom 14 is not limited to being perpendicular to the axial direction AD. The bottom 14 may be substantially perpendicular to the axial direction AD or may intersect the axial direction AD. The bottom 14 is opposed to a base end surface 34 of the plunger 30 which will be described below. The bottom 14 is caulked and fixed to the thin portion 13 formed in the tubular portion 12.

In the coil 20, a lead wire coated with insulation is wound onto a bobbin 22 made of resin. The bobbin 22 is arranged radially inside the tubular portion 12 of the yoke 10. An end of the lead wire of the coil 20 is connected to a connection terminal 24. The connection terminal 24 is arranged in a connector 26. The connector 26 is arranged in an outer peripheral side of the yoke 10 and electrically connects the solenoid 100 to the electronic control device through an unillustrated connection line.

Because of the coil 20, magnetic force is generated by the energization, and a magnetic flux is formed so as to loop and pass through the tubular portion 12 of the yoke 10, the stator core 40, and the plunger 30. The magnetic flux is referred to as magnetic circuit hereinafter. In a state shown in FIGS. 1 and 2, the coil 20 is not energized, and the magnetic circuit is not formed. However, for convenience of explanation, FIG. 2 shows the magnetic circuit formed by the energization to the coil 20.

The plunger 30 has an appearance of a substantially cylindrical shape and is made of magnetic metal. The plunger 30 slides in the axial direction AD radially inside a core portion 61 of the stator core 40 which will be described below. The shaft 90 abuts against one end surface of the plunger 30 close to the spool valve 200, referred to as front end surface 32 hereinafter. Because of biasing force caused by the spring 230 and transmitted to the spool 220, the plunger 30 is biased toward the bottom 14 along the axial direction AD. The other end surface of the plunger 30 on an opposite side of the front end surface 32 is referred to as base end surface 34 hereinafter and is opposed to the bottom 14. An unillustrated ventilation hole penetrates the plunger 30 in the axial direction AD. Fluid such as the hydraulic oil and air passes through the ventilation hole between an area close to the base end surface 34 of the plunger 30 and an area close to the front end surface 32 of the plunger 30.

The stator core 40 is made of magnetic metal and is disposed between the coil 20 and the plunger 30. The stator core 40 includes a magnetic attraction core 50, a slide core 60, and a magnetic flux passage restricting portion 70.

The magnetic attraction core 50 surrounds the shaft 90 in a circumferential direction. The magnetic attraction core 50 is a part of the stator core 40 and located close to the spool valve 200. The magnetic attraction core 50 magnetically attracts the plunger 30 by the magnetic force generated by the coil 20. A stopper 52 is arranged on the magnetic attraction core 50 at a surface opposed to the front end surface 32 of the plunger 30. The stopper 52 is made of non-magnetic material and is configured to restrict the plunger 30 and the magnetic attraction core 50 from directly abutting against each other. In addition, the stopper 52 is configured to restrict the plunger 30 from being inseparable from the magnetic attraction core 50 because of the magnetic attraction.

The slide core 60 is a part of the stator core 40 and located close to the bottom 14. The slide core 60 is arranged radially outside the plunger 30. The slide core 60 includes a core portion 61 and a magnetic flux transmitting portion 65.

The core portion 61 has an appearance of a substantially cylindrical shape and is disposed between the coil 20 and the plunger 30 in the radial direction. The core portion 61 is configured to guide the plunger 30 to move along the axial direction AD. Therefore, the plunger 30 slides directly on an inner peripheral surface of the core portion 61. An unillustrated sliding gap is provided between the core portion 61 and the plunger 30 to ensure slidability of the plunger 30. An end portion of the slide core 60 on an opposite side of the magnetic attraction core 50 is referred to as end portion 62 hereinafter. The end portion 62 is opposed to the bottom 14 and abuts against the bottom 14.

The magnetic flux transmitting portion 65 expands radially outward from the end portion 62 over an entire circumference of the end portion 62. That is, the magnetic flux transmitting portion 65 is arranged between the bobbin 22 and the bottom 14 in the axial direction AD. The magnetic flux transmitting portion 65 is configured to transmit the magnetic flux between the yoke 10 and the plunger 30 through the core portion 61. More specifically, the magnetic flux is transmitted from the tubular portion 12 of the yoke 10 to the plunger 30 through the magnetic flux transmitting portion 65. The magnetic flux may be transmitted from the bottom 14 to the plunger 30 through the magnetic flux transmitting portion 65.

In the present embodiment, the magnetic flux transmitting portion 65 is housed in an inner peripheral side of the thin portion 13 of the tubular portion 12. A small gap is provided between the outer peripheral surface of the magnetic flux transmitting portion 65 and the inner peripheral surface of the thin portion 13 in order to assemble. The magnetic flux transmitting portion 65 abuts against the bobbin 22 and the bottom 14 in the axial direction AD.

The magnetic flux passage restricting portion 70 is formed between the magnetic attraction core 50 and the core portion 61 in the axial direction AD. The magnetic flux passage restricting portion 70 is configured to restrict the magnetic flux from flowing directly between the core portion 61 and the magnetic attraction core 50. In the present embodiment, a thickness of the magnetic flux passage restricting portion 70 in the radial direction is thinner than those of the other portions included in the stator core 40. Therefore, magnetic resistance of the magnetic flux passage restricting portion 70 is larger than those of the magnetic attraction core 50 and the core portion 61.

In the present embodiment, the yoke 10, the bottom 14, the plunger 30, and the stator core 40 are made of iron. However, the material of the above elements is not limited to iron and may be arbitrary magnetic material such as nickel or cobalt. In addition, the stator core 40 is formed by forging in the present embodiment, however, may be formed by other arbitrary molding method.

For convenience of explanation, a thick arrow in FIG. 2 schematically shows the magnetic circuit generated by the energization. The magnetic circuit passes through the tubular portion 12 of the yoke 10, the magnetic flux transmitting portion 65 of the stator core 40, the core portion 61 of the stator core 40, the plunger 30, the magnetic attraction core 50 of the stator core 40, and the wall portion 18 of the yoke 10, Therefore, the plunger 30 is attracted toward the magnetic attraction core 50 by the energization to the coil 20. Thereby, the plunger 30 slides in a direction shown by a white arrow in the axial direction AD, at a location radially inside the core portion 61, in other words, radially inside the slide core 60. In this way, by the energization of the coil 20, the plunger 30 is moved toward the magnetic attraction core 50 against the biasing force of the spring 230. As a current which flows through the coil 20 is large, magnetic flux density of the magnetic circuit is increased, and a stroke amount of the plunger 30 is increased. The stroke amount of the plunger 30 corresponds to an amount in which the plunger 30 is moved along the axial direction AD from a reference point on which the plunger 30 is the farthest from the magnetic attraction core 50 toward the magnetic attraction core 50, in reciprocation of the plunger 30. When the plunger 30 is the farthest from the magnetic attraction core 50, the solenoid 100 is in the non-energized state. On the other hand, unlike FIG. 2, when the plunger 30 is the closest to the magnetic attraction core 50, the coil 20 is energized, and the front end surface 32 of the plunger 30 abuts against the stopper 52. At this point, the stroke amount of the plunger 30 is the largest.

When the plunger 30 is moved toward the magnetic attraction core 50, the shaft 90 which abuts against the front end surface 32 of the plunger 30 presses the spool 220 shown in FIG. 1 toward the spring 230. As a result, the communication state and the opening area of the oil port 214 are controlled, and the hydraulic pressure is output proportional to a value of the current which flows in the coil 20.

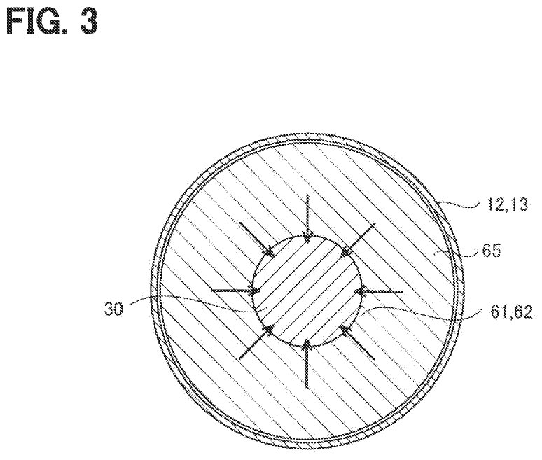

As shown in FIG. 3, in the slide core 60 in the present embodiment, the core portion 61 and the magnetic flux transmitting portion 65 are formed integrally. That is, a gap is not provided between the core portion 61 and the magnetic flux transmitting portion 65 in the radial direction. Therefore, when the magnetic circuit is formed by the energization, the distribution of the magnetic flux transmitted from the magnetic flux transmitting portion 65 to the core portion 61 is restricted from being biased in the radial direction. In addition, the distribution of the magnetic flux transmitted from the core portion 61 to the plunger 30 is restricted from being biased in the radial direction. In other words, as shown by an arrow in FIG. 3, the magnetic flux density of the magnetic circuit is substantially equal in the circumferential direction. Therefore, generation of side force due to bias of the magnetic flux distribution can be restricted.

### A-2. Comparative Example

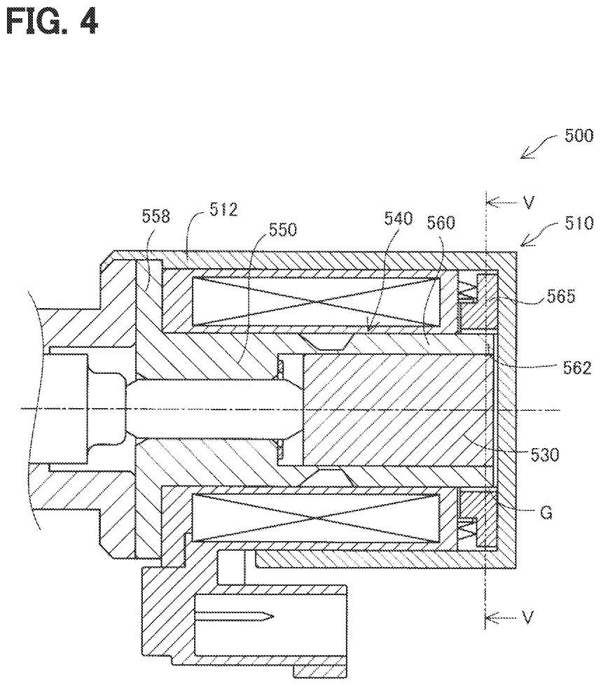

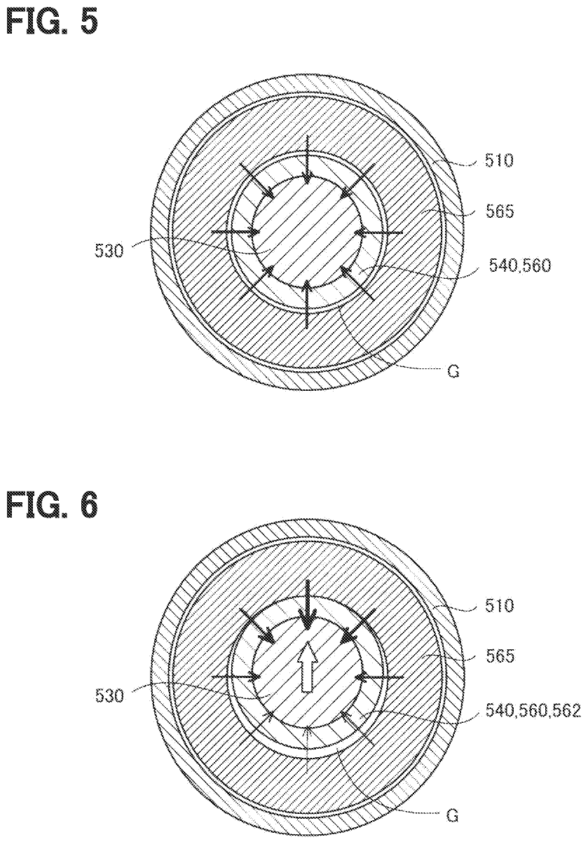

FIGS. 4 and 5 show a solenoid 500 in a comparative example. A ring core 565 is made of magnetic material, and a stator core 540 is formed in a substantially cylindrical shape. In the solenoid 500, the ring core 565 is arranged radially outside a slide core 560 of the stator core 540. The ring core 565 is configured to transmit the magnetic flux between a yoke 510 and a plunger 530. In addition, as shown in FIG. 4, a flange 558 protrudes radially outward and is provided on an end part of a magnetic attraction core 550 of the stator core 540 at an opposite side of the plunger 530 in the axial direction AD. The magnetic flux is transmitted between the magnetic attraction core 550 and a tubular portion 512 of the yoke 510 through the flange 558. In the solenoid 500 in the comparative example, the flange 216 of the spool valve 200 and the tubular portion 512 are caulked and fixed while the flange 558 is held between the coil 20 and the flange 216 of the spool valve 200, and thereby the stator core 540 is fixed to the yoke 510. As shown in FIGS. 4 and 5, in the solenoid 500 in the comparative example, a gap C is provided between the slide core 560 and the ring core 565 in the radial direction. In the structure described above, the ring core 565 is movable in the radial direction. Therefore, displacement of an end portion 562 of the slide core 560 in the radial direction caused by the dimensional variation of the stator core 540 in the manufacturing and by the axis deviation in the assembly is absorbed.

FIG. 6 is a sectional view similar to FIG. 5 and shows the ring core 565 assembled in a state the most eccentric to the slide core 560. If the ring core 565 is assembled eccentrically with respect to the slide core 560, a size of the gap G provided between the slide core 560 and the ring core 565 may be biased in the radial direction. Generally, the magnetic flux generated by the energization is transmitted preferentially in an area in which the magnetic resistance is small, compared to an area in which the magnetic resistance is large. Therefore, in a state shown in FIG. 6, as shown by thick arrows, the magnetic flux density is increased in an area in which the gap G between the slide core 560 and the ring core 565 in the radial direction is small. On the other hand, the magnetic flux density is decreased in an area in which the gap G between the slide core 560 and the ring core 565 in the radial direction is large, as shown by thin arrows. In this case, as the distribution of the magnetic flux transmitted to the slide core 560 and the plunger 530 through the ring core 565 may be biased in the radial direction, the attractive force in the radial direction may be generated as the side force, as shown by a white arrow in FIG. 6. If the side force is increased, the slidability of the plunger 530 may be deteriorated.

In contrast, in the solenoid 100 in the present embodiment, a gap is not provided between the core portion 61 and the magnetic flux transmitting portion 65. Therefore, the distribution of the magnetic flux transmitted from the magnetic flux transmitting portion 65 to the plunger 30 through the core portion 61 can be protected from being biased in the radial direction. Because of this, the generation of the side force due to the bias of the magnetic flux distribution can be restricted. Unlike the solenoid 500 in the comparative example, the stator core 40 of the solenoid 100 in the present embodiment does not include the flange 558. The yoke 10 includes the wall portion 18 which extends inward from the tubular portion 12 in the radial direction. Therefore, as described above, the small gap required to assemble the solenoid 100 is provided between the wall portion 18 and the stator core 40 in the radial direction.

In the solenoid 100 in the first embodiment described above, the slide core 60 includes the core portion 61 and the magnetic flux transmitting portion 65. The core portion 61 is formed in a tubular shape and is arranged radially outside the plunger 30. The magnetic flux transmitting portion 65 expands radially outward from the end portion 62 of the core portion 61, Therefore, the gap is not provided between the core portion 61 and the magnetic flux transmitting portion 65 in the radial direction. Therefore, the distribution of the magnetic flux transmitted from the magnetic flux transmitting portion 65 to the plunger 30 through the core portion 61 can be protected from being biased in the radial direction, and the generation of the side force due to the bias of the magnetic flux distribution can be restricted. Therefore, the slidability of the plunger 30 can be restricted from being deteriorated.

In addition, as a gap is not provided around the end portion 62 of the core portion 61 except the sliding gap, magnetic efficiency can be restricted from being reduced. Furthermore, as the stator core 40 is formed by a single member which integrally includes the magnetic attraction core 50, the slide core 60, and the magnetic flux passage restricting portion 70, the number of the component can be restricted from being increased.

### B. Second Embodiment

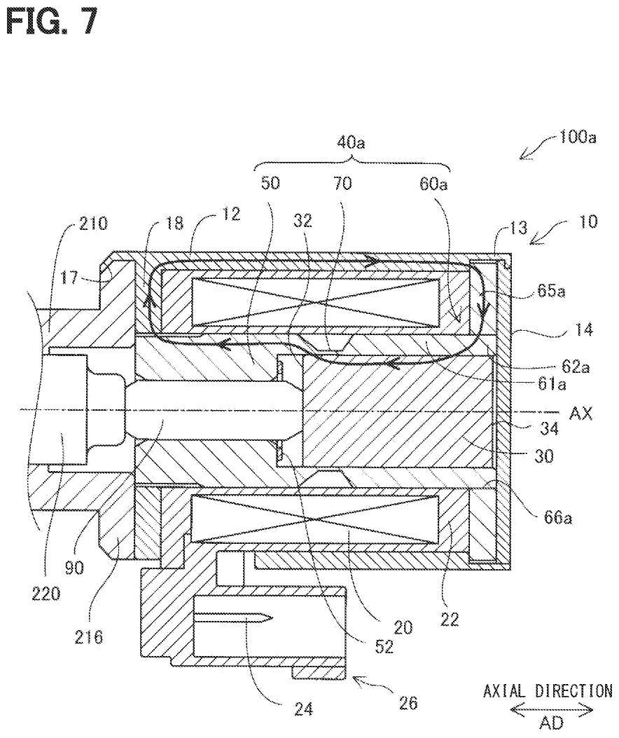

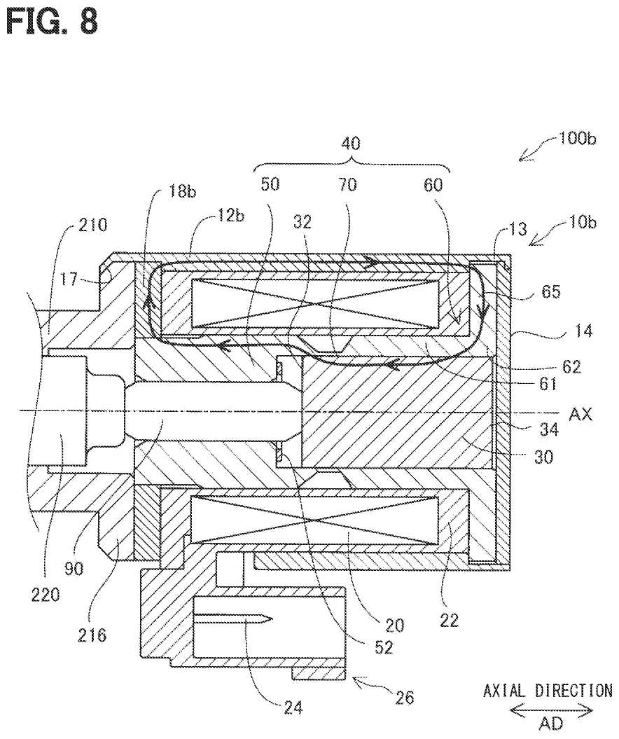

FIG. 7 shows a solenoid 100a in a second embodiment, The solenoid 100a is different from the solenoid 100 in the first embodiment so as to include a stator core 40a instead of the stator core 40. Other structures are similar to those of the solenoid 100 in the first embodiment. Therefore, the same reference numerals are given to the same structures, and the explanation for the structures with the same reference numerals is eliminated. In a state shown in FIG. 7, the coil 20 is not energized, and the magnetic circuit is not formed. However, for convenience of explanation, FIG. 7 shows the magnetic circuit formed by the energization to the coil 20. Similarly, the magnetic circuit is illustrated in FIGS. 8 to 13 which will be described below.

In the second embodiment, a slide core 60a of the stator core 40a included in the solenoid 100a includes a core portion 61a and a magnetic flux transmitting portion 65a which are formed separately. The magnetic flux transmitting portion 65a has an appearance of a ring shape. A through hole 66a is provided in the magnetic flux transmitting portion 65a to extend in the axial direction AD and penetrates an inner peripheral side of the magnetic flux transmitting portion 65a in the radial direction, An end portion 62a of the core portion 61a is inserted by pressing and fitted to the through hole 66a. The core portion 61a and the magnetic flux transmitting portion 65a are assembled by press fitting so as to become an integral structure. Therefore, a gap in the radial direction is approximately not provided between the core portion 61a and the magnetic flux transmitting portion 65a. The core portion 61a may be integrated with the magnetic flux transmitting portion 65a by welding or the like, not only by the press fitting, after being inserted into the through hole 66a.

The solenoid 100a in the second embodiment described above has the same effect as the solenoid 100 in the first embodiment. Additionally, the magnetic flux transmitting portion 65a is formed separately from the core portion 61a and includes the through hole 66a. The core portion 61a is inserted into the through hole 66a and integrated with the magnetic flux transmitting portion 65a. Therefore, a structure of the stator core 40a can be restricted from being complicated, and an increase in a manufacturing cost of the stator core 40a can be restricted.

### C. Third Embodiment

FIG. 8 shows a solenoid 100b in a third embodiment. The solenoid 100b is different from the solenoid 100 in the first embodiment so as to include a yoke 10b, instead of the yoke 10, and a ring member 18b. Other structures are similar to those of the solenoid 100 in the first embodiment. Therefore, the same reference numerals are given to the same structures, and the explanation for the structures with the same reference numerals is eliminated.

In the yoke 10b included in the solenoid 100b in the third embodiment, the wall portion 18 is not provided on a tubular portion 12b. Further, in the solenoid 100b in the third embodiment, a ring member 18b is arranged at a position on which the wall portion 18 is provided in the first embodiment. In other words, the ring member 18b is arranged radially outside an end portion of the magnetic attraction core 50 on the opposite side of the plunger 30 in the axial direction AD. The ring member 18b has an appearance of a ring shape and is made of magnetic metal, The ring member 18b is configured to transmit the magnetic flux between the magnetic attraction core 50 of the stator core 40 and the tubular portion 12b of the yoke 10b. The ring member 18b is not fixed to the tubular portion 12b and is displaceable in the radial direction.

The solenoid 100b in the third embodiment described above has the same effect as the solenoid 100 in the first embodiment. In addition, the ring member 18b formed in a ring shape is arranged at the position on which the wall portion 18 is provided in the first embodiment. Therefore, the dimensional variation of the stator core 40 in the manufacturing and the axial deviation in the assembly are absorbed. Further, the ring member 18b is not fixed to the tubular portion 12b of the yoke 10b. Therefore, a gap provided radially outside the stator core 40 can be restricted from being excessively large in order to absorb the axial deviation in the assembly of the tubular portion 12b and the stator core 40. That is, as a radial gap between the ring member 18b and the stator core 40 can be smaller, the magnetic efficiency can be restricted from being reduced. In addition, as the wall portion 18 is omitted, the yoke 10b is restricted from having a complicated structure, and an increase in a manufacturing cost of the yoke 10b can be restricted.

### D. Fourth Embodiment

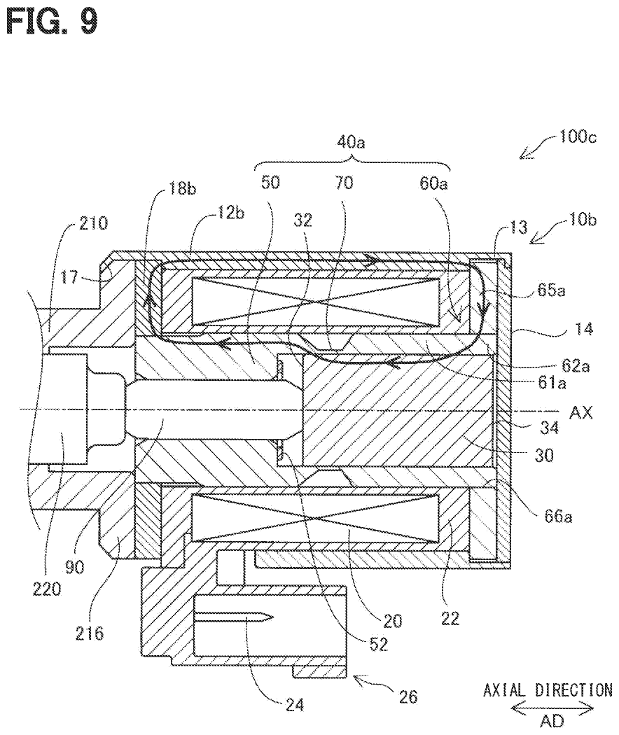

FIG. 9 shows a solenoid 100c in a fourth embodiment. The solenoid 100c is different from the solenoid 100b in the third embodiment so as to include the stator core 40a in the second embodiment, instead of the stator core 40. Other structures are similar to those of the solenoid 100b in the third embodiment. Therefore, the same reference numerals are given to the same structures, and the explanation for the structures with the same reference numerals is eliminated.

The solenoid 100c in the fourth embodiment has a structure in which the solenoid 100a in the second embodiment and the solenoid 100b in the third embodiment are combined. The end portion 62a is an end portion of the stator core 40a close to the bottom 14 in the axial direction AD. The end portion 62a is inserted by pressing and fitted to the through hole 66a of the magnetic flux transmitting portion 65a. The ring member 18b is arranged radially outside the end portion of the stator core 40a and positioned close to the spool valve 200 in the axial direction AD.

The solenoid 100c in the fourth embodiment described above has the same effect as the solenoid 100a in the second embodiment and the solenoid 100b in the third embodiment. Additionally, as radial gaps at end sides of the stator core 40a in the axial direction AD can be smaller, the reduction of the magnetic efficiency can be further restricted.

### E. Fifth Embodiment

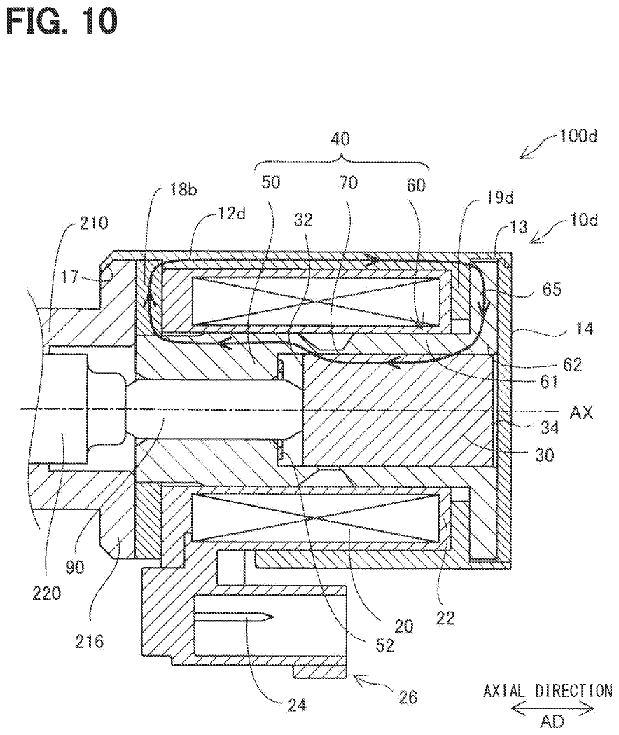

FIG. 10 shows a solenoid 100d in a fifth embodiment. The solenoid 100d is different from the solenoid 100b in the third embodiment so as to include a tubular portion 12d, instead of the tubular portion 12b. Other structures are similar to those of the solenoid 100b in the third embodiment. Therefore, the same reference numerals are given to the same structures, and the explanation for the structures with the same reference numerals is eliminated.

The tubular portion 12d included in the solenoid 100d in the fifth embodiment includes a magnetic flux passage area expansion portion 19d. The magnetic flux passage area expansion portion 19d is positioned between the magnetic flux transmitting portion 65 and the coil 20 in the axial direction AD and is formed radially inward from the tubular portion 12d. The magnetic flux passage area expansion portion 19d abuts against the magnetic flux transmitting portion 65 and the coil 20. The magnetic flux passage area expansion portion 19d is provided such that the magnetic flux is transmitted from the tubular portion 12d to the magnetic flux transmitting portion 65 through an area equal to a predetermined threshold area or larger. The threshold area is set so as not to reduce the magnetic efficiency of the solenoid 100d because of an excessive small area through which the magnetic flux passes. As shown by a loop arrow in FIG. 10, when the solenoid 100d is energized, the magnetic circuit is formed and is transmitted sequentially to the tubular portion 12d, the magnetic flux passage area expansion portion 19d, the magnetic flux transmitting portion 65, and the core portion 61.

The solenoid 100d in the fifth embodiment described above has the same effect as the solenoid 100b in the third embodiment. In addition, the magnetic flux passage area expansion portion 19d is provided on the tubular portion 12d such that the area through which the magnetic flux is transmitted from the tubular portion 12d to the magnetic flux transmitting portion 65 is equal to the predetermined threshold area or larger. Because of this, a shortage of the area through which the magnetic flux passes between the tubular portion 12d and the magnetic flux transmitting portion 65 is restricted. A relative position between the tubular portion 12d and the magnetic flux transmitting portion 65 may be deviated in the radial direction because of the dimensional variation of the stator core 40 in the manufacturing or because of the axis deviation in the assembly. Even in this case, because of the magnetic flux passage area expansion portion 19d, the shortage of the area through which the magnetic flux transmitted from the tubular portion 12d to the magnetic flux transmitting portion 65 passes is restricted.

### F. Sixth Embodiment

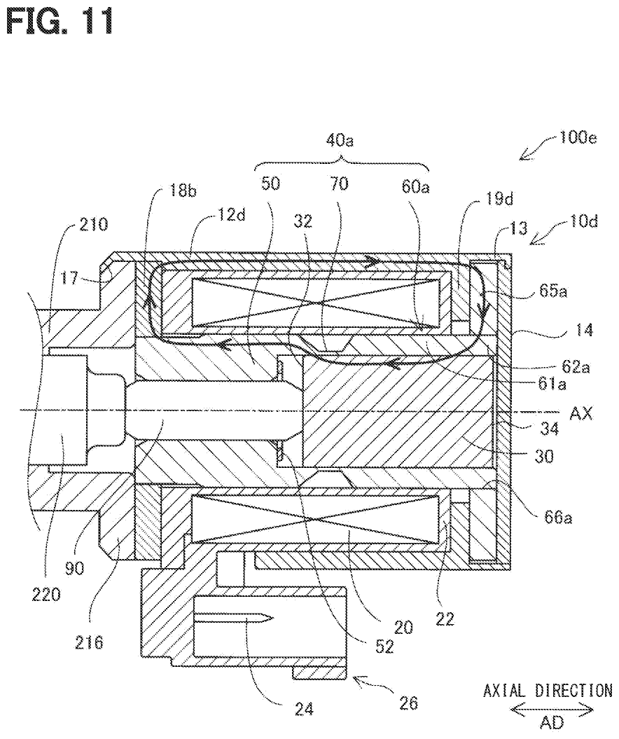

FIG. 11 shows a solenoid 100e in a sixth embodiment. The solenoid 100e is different from the solenoid 100d in the fifth embodiment so as to include the stator core 40a in the second embodiment, instead of the stator core 40. Other structures are similar to those of the solenoid 100d in the fifth embodiment. Therefore, the same reference numerals are given to the same structures, and the explanation for the structures with the same reference numerals is eliminated.

The solenoid 100e in the sixth embodiment has a structure in which the solenoid 100a in the second embodiment and the solenoid 100d in the fifth embodiment are combined.

The solenoid 100e in the sixth embodiment described above has the same effect as the solenoid 100a in the second embodiment and the solenoid 100d in the fifth embodiment.

### G. Seventh Embodiment

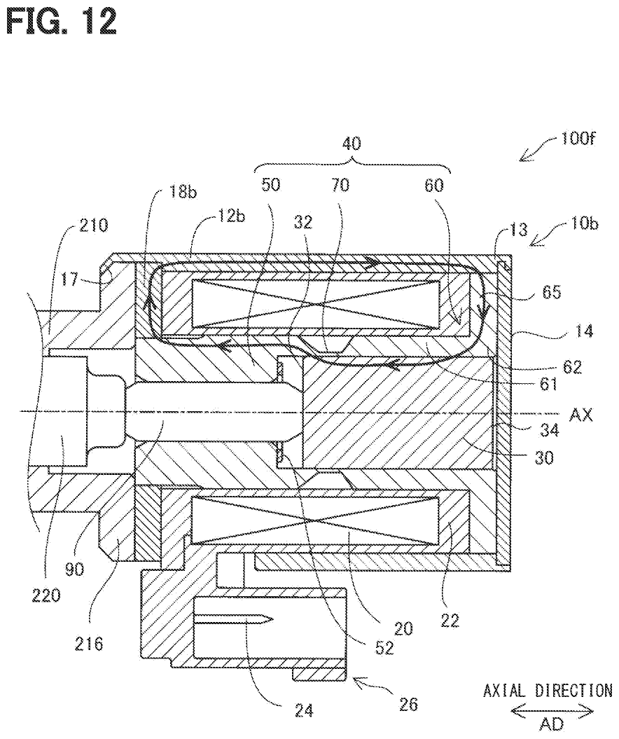

FIG. 12 shows a solenoid 100f in a seventh embodiment. The solenoid 100f is different from the solenoid 100b in the third embodiment such that a length of the thin portion 13 in the axial direction AD is slightly shorter than that in the third embodiment and that the stator core 40 is inserted by pressing and fitted to the tubular portion 12b of the yoke 10. Other structures are similar to those of the solenoid 100b in the third embodiment. Therefore, the same reference numerals are given to the same structures, and the explanation for the structures with the same reference numerals is eliminated.

The stator core 40 included in the solenoid 100f in the seventh embodiment is inserted by pressing and fitted to an end portion of the tubular portion 12b close to the thin portion 13. Because of the press fitting, a gap in the radial direction is approximately not provided between an inner peripheral surface of the tubular portion 12b and an outer peripheral surface of the magnetic flux transmitting portion 65.

The solenoid 100f in the seventh embodiment described above has the same effect as the solenoid 100b in the third embodiment. In addition, as the gap between the inner peripheral surface of the tubular portion 12b and the outer peripheral surface of the magnetic flux transmitting portion 65 in the radial direction can be omitted, the reduction of the magnetic efficiency can be restricted. Further, the area through which the magnetic flux is transmitted from the tubular portion 12b to the magnetic flux transmitting portion 65 can be equal to the predetermined threshold area or larger easily.

### H. Eighth Embodiment

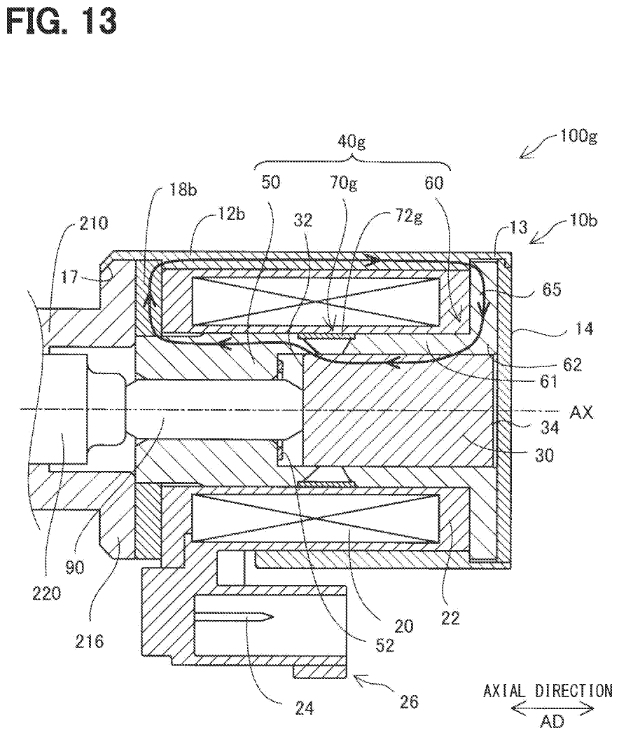

FIG. 13 shows a solenoid 100a in an eighth embodiment. The solenoid 100g is different from the solenoid 100b in the third embodiment so as to include a stator core 40g which includes a magnetic flux passage restricting portion 70g instead of the magnetic flux passage restricting portion 70. Other structures are similar to those of the solenoid 100b in the third embodiment. Therefore, the same reference numerals are given to the same structures, and the explanation for the structures with the same reference numerals is eliminated.

The magnetic flux passage restricting portion 70g of the solenoid 100g in the eighth embodiment includes a connecting portion 72g made of non-magnetic material. The magnetic attraction core 50 and the slide core 60 are separated from each other, and the connecting portion 72g physically connects the magnetic attraction core 50 to the slide core 60. In the present embodiment, the connecting portion 72g is thinner than the core portion 61 and physically connects the magnetic attraction core 50 to the slide core 60 in an inner peripheral side of the coil 20. Therefore, a gap is provided between an inner peripheral surface of the connecting portion 72g and an outer peripheral surface of the plunger 30. In the present embodiment, the connecting portion 72g is made of austenitic stainless steel, however, may be made of arbitrary non-magnetic material such as aluminum or brass, not only of the austenitic stainless steel.

The solenoid 100g in the eighth embodiment described above has the same effect as the solenoid 100b in the third embodiment. In addition, the magnetic flux passage restricting portion 70g includes the connecting portion 72g made of non-magnetic material. Therefore, when energized, the magnetic flux is restricted from passing directly from the core portion 61 to the magnetic attraction core 50 without passing through the plunger 30.

### I. Ninth Embodiment

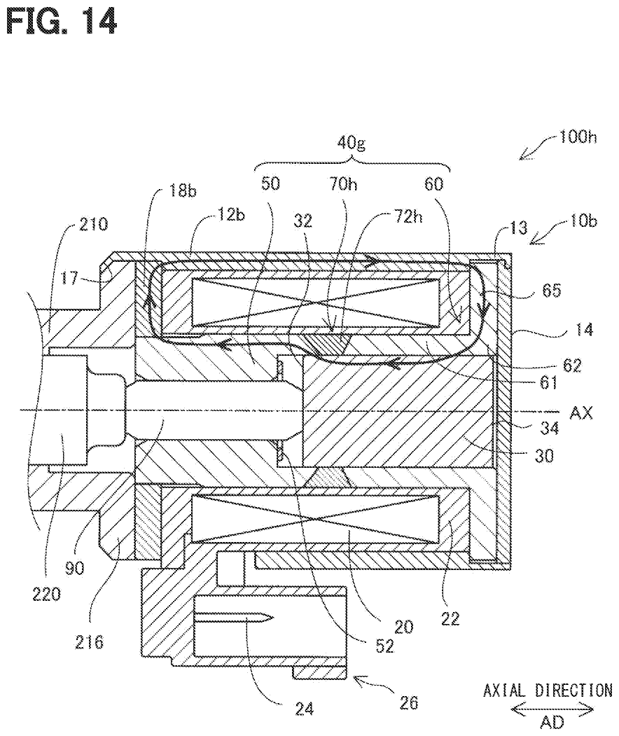

FIG. 14 shows a solenoid 100h in a ninth embodiment. The solenoid 100h is different from the solenoid 100g in the eighth embodiment so as to include a magnetic flux passage restricting portion 70h which includes a connecting portion 72h instead of the connecting portion 72g, Other structures are similar to those of the solenoid 100g in the eighth embodiment. Therefore, the same reference numerals are given to the same structures, and the explanation for the structures with the same reference numerals is eliminated.

The connecting portion 72h in the solenoid 100h in the ninth embodiment has a thickness substantially equal to that of the core portion 61 and is formed by brazing or the like.

The solenoid 100h in the ninth embodiment described above has the same effect as the solenoid 100g in the eighth embodiment. In addition, the connecting portion 72h has the thickness substantially equal to that of the core portion 61. Therefore, the magnetic attraction core 50 and the core portion 61 can be connected firmly to each other. Further, the connecting portion 72h is configured to guide a slide of the plunger 30.

J. Other Embodiments

(1) In the fifth embodiment and the sixth embodiment, the magnetic flux passage area expansion portion 19d is provided between the magnetic flux transmitting portion 65 and the coil 20 in the axial direction AD and is formed radially inward from the tubular portion 12d. However, the present disclosure is not limited to this structure. For example, similarly to the solenoid 100f in the seventh embodiment, the stator core 40 may be pressed and fitted to the tubular portion 12 of the yoke 10. Because of this, the magnetic flux is transmitted from the tubular portion 12 to the magnetic flux transmitting portion 65 through the area equal to the predetermined threshold area or larger. In the above structure, a part on the tubular portion 12 to which the magnetic flux transmitting portion 65 is inserted by pressing and fitted corresponds to the magnetic flux passing area expansion portion in the present disclosure. That is, generally, the yoke may include the magnetic flux passing area expansion portion such that the magnetic flux passes from the yoke to the magnetic flux transmitting portion through an area equal to a predetermined threshold area or larger. Effects similar to those in the embodiment described above are produced also by the configuration described above.

(2) The configurations of the solenoid 100, 100a to 100h in the embodiments described above are merely examples and may be modified in various manners. For example, in the embodiments described above, the bottom 14 is made of magnetic metal. However, the bottom 14 may be made of non-magnetic material such as aluminum, not only magnetic material. In this configuration, generation of force so as to attract the plunger 30 to the bottom 14 can be restricted, and the reduction of the magnetic efficiency can be further restricted. In addition, magnetic foreign matter contained in the hydraulic oil in the hydraulic circuit is restricted from adhering to the bottom 14. Further, the bottom 14 may be fixed to the yoke 10, 10b, 10d by an arbitrary fixing method such as welding, not only by caulking fixation. In addition, the bottom 14 may be fixed to the yoke 10, 10b, 10d in a situation that a gap is provided between the bottom 14 and the magnetic flux transmitting portion 65, 65a in the axial direction AD.

That is, the bottom 14 and the magnetic flux transmitting portion 65, 65a may not be joined to each other by pressure welding. Further, the bottom 14 may be fixed to the magnetic flux transmitting portion 65, 65a, not to the yoke 10, 10b, 10d. In addition, the plunger 30 is not limited to have a substantially cylindrical shape and may have an appearance of a substantially columnar shape, for example. In addition, the core portion 61, 61a and the tubular portion 12, 12b, 12d of the yoke 10, 10b, 10d are not limited to have a substantially cylindrical shape and may have a tubular shape corresponding to the appearance of the plunger 30. In addition, the yoke 10, 10b, 10d may have a substantially cylindrical shape, or may have a predetermined tubular shape in which a sectional view has a substantially quadrangular shape or the like. Additionally, the yoke 10, 10b, 10d is not limited to have a tubular shape and may have a plate shape or the like so as to surround the coil 20 and the plunger 30. Effects similar to those in the embodiment described above are produced also by the configuration described above.

(3) The solenoid 100, 100a to 100h in the above embodiments is applied to the linear solenoid valve 300 configured to control the hydraulic pressure of the hydraulic oil supplied to the vehicle automatic transmission. In addition, the solenoid 100, 100a to 100h in the above embodiments functions as the actuator configured to drive the spool valve 200. However, the present disclosure is not limited to the above. For example, the solenoid 100, 100a to 100h may be applied to an arbitrary solenoid valve such as an electromagnetic oil passage selector valve of a valve timing control device configured to control valve timing of an intake valve or an exhaust valve for an engine. In addition, for example, an arbitrary valve such as a poppet valve may be driven instead of the spool valve 200, and an arbitrary driven body such as a switch may be driven instead of the valve.

The present disclosure should not be limited to the embodiments described above, and various other embodiments may be implemented without departing from the scope of the present disclosure. For example, the technical features in the embodiments corresponding to the technical features in the form described in the summary may be replaced or combined as appropriate in order to solve a part or all of the issues described above or to achieve a part or all of effects described above. In addition, as long as a technical feature is not described as essential in the present specification, the technical feature may be deleted as appropriate.

What is claimed is:

1. A solenoid comprising:
a coil configured to generate magnetic force when energized;
a plunger formed in a columnar shape, arranged radially inside the coil, and configured to slide in an axial direction;
a yoke that houses the coil and the plunger, includes a tubular portion, and is provided along the axial direction;
a bottom provided along a direction that intersects the axial direction and opposed to a base end surface of the plunger; and
a stator core,
wherein,
the stator core includes
a magnetic attraction core that is opposed to a front end surface of the plunger in the axial direction and configured to magnetically attract the plunger by magnetic force generated by the coil,
a slide core that includes:
a core portion formed in a tubular shape and arranged radially outside the plunger; and
a magnetic flux transmitting portion that expands radially outward from an end portion of the core portion that is opposed to the bottom, and configured to transmit magnetic flux between the yoke and the plunger through the core portion, and
a magnetic flux passage restricting portion configured to restrict passage of the magnetic flux between the slide core and the magnetic attraction core,
the yoke includes a magnetic flux passage area expansion portion such that the magnetic flux passes from the yoke to the magnetic flux transmitting portion through an area equal to a predetermined area threshold or larger, and
the magnetic flux passage area expansion portion is formed on the tubular portion and protrudes radially inward from an inner peripheral surface of the tubular portion.

2. The solenoid according to claim 1, further comprising:
a ring member formed in a ring shape and arranged radially outside an end portion of the magnetic attraction core on an opposite side of the plunger in the axial direction, wherein
the ring member is configured to transmit the magnetic flux between the yoke and the magnetic attraction core.

3. The solenoid according to claim 1, wherein
the magnetic flux transmitting portion is formed separately from the core portion and includes a through hole, and
the core portion is inserted in the through hole and is integrated with the magnetic flux transmitting portion.

4. The solenoid according to claim 1, wherein
the magnetic flux passage restricting portion includes a connecting portion that is made of non-magnetic material and physically connects the magnetic attraction core to the slide core.
